(19) United States
(12) Patent Application Publication
(10) Pub. No.: US 2010/0070676 A1
(43) Pub. Date: Mar. 18, 2010

(54) Memory Data Bus Placement and Control

(75) Inventor: Hoon Ryu, Cary, NC (US)

Correspondence Address: COATS & BENNETT/QIMONDA, 1400 CRESCENT GREEN, SUITE 300, CARY, NC, 27518, US

(73) Assignee: Qimonda North America Corporation, Cary, NC (US)

(21) Appl. No.: 12/209,542

(22) Filed: Sep. 12, 2008

(51) Int. Cl. G06F 12/06

(52) U.S. Cl. 711/5; 711/E12.082

(57) ABSTRACT

In one embodiment, a memory device comprises a plurality of memory banks. At least two of the memory banks share the same bus. Logic is coupled to the memory banks via the different buses. The logic controls access to the memory banks. A bi-directional tri-state buffer is interposed between adjacent memory banks along the same bus so that each bus is segmented into a plurality of sections, each bus section being coupled to one or more different ones of the memory banks.

### BACKGROUND OF THE INVENTION

Memory devices typically have several independently accessible arrays of memory cells for storing information commonly known as ‘banks’. The memory banks, along with other support logic, are fabricated on a semiconductor substrate to yield a memory device. Logic common to all banks is typically arranged in a central part of the substrate. The common logic controls access to different ones of the banks during memory operations such as reads and writes. Each different bank is conventionally coupled to the common logic via a separate, dedicated data bus. Data is read from and written to the different banks over the dedicated buses. Each bus coupled to a memory bank has a width corresponding to the width of the bank, e.g., 32 bits. To increase the capacity of a memory device, more banks are usually added to the device. However, a new bus is also conventionally added for each new bank for coupling the new banks to the common logic of the memory device. The overall bus size and power approximately doubles each time the number of memory banks included in a memory device doubles.

### SUMMARY OF THE INVENTION

In one embodiment, a memory device comprises a plurality of memory banks. At least two of the memory banks share the same bus. Logic is coupled to the memory banks via the different buses. The logic controls access to the memory banks. A bi-directional tri-state buffer is interposed between adjacent memory banks along the same bus so that each bus is segmented into a plurality of sections, each bus section being coupled to one or more different ones of the memory banks.

Of course, the present invention is not limited to the above features and advantages. Those skilled in the art will recognize additional features and advantages upon reading the following detailed description, and upon viewing the accompanying drawings.

### BRIEF DESCRIPTION OF THE DRAWINGS

FIG. 1 is a block diagram of an embodiment of a memory device.

FIG. 2 is a logic flow diagram of an embodiment of a method for fabricating a memory device.

FIG. 3 is a logic flow diagram of an embodiment of a method for operating a memory device.

FIG. 4 is a block diagram of another embodiment of a memory device.

FIG. 5 is a block diagram of yet another embodiment of a memory device.

FIG. 6 is a block diagram of an embodiment of a bi-directional tri-state buffer element included in a memory device.

### DETAILED DESCRIPTION OF THE INVENTION

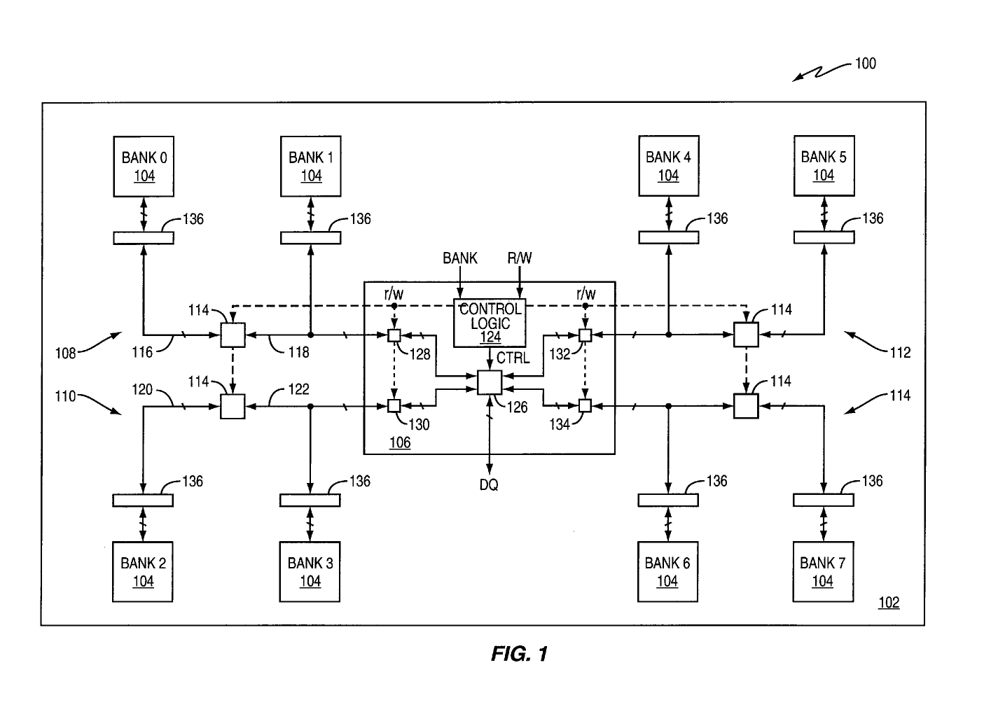

FIG. 1 illustrates an embodiment of a memory device 100. The memory device 100 is fabricated on a semiconductor substrate 102 and includes a plurality of separately addressable memory banks 104. Any number of memory banks 104 may be included in the memory device 100. Each bank 104 includes an array of memory cells. The memory cells may be any type of volatile or non-volatile memory such as Dynamic Random Access Memory (DRAM), embedded-DRAM, Static Random Access Memory (SRAM), Magneto-resistive Random Access Memory (MRAM), FLASH, etc. A memory cell is accessed by selecting the bank 104 containing the desired cell and activating the row and column address at the intersection of which the cell is located. The memory device 100 also includes logic 106 that is common to each of the banks 104 and which controls access to the banks 104 during memory operations such as reads and writes.

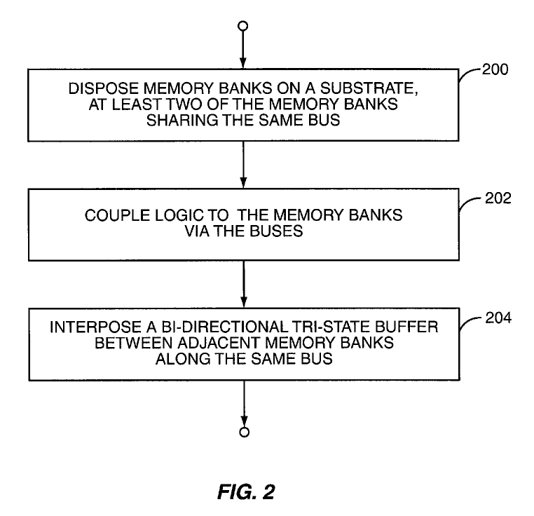

FIG. 2 illustrates an embodiment of a method for fabricating the memory device 100. The memory banks 104 are disposed on the substrate 102, two or more different ones of the banks 104 sharing the same data bus (Step 200). This way, a different data bus is not used for each bank 104 included in the memory device 100. Instead, two or more of the banks 104 are grouped together and share the same bus. FIG. 1 shows one embodiment where the banks 104 are arranged in rows. Particularly, a first row of the banks 104 including Bank0 and Bank1 is coupled to a first bus 108. A second row of the banks 104 including Bank2 and Bank3 is coupled to a second bus 110. A third row of the banks 104 including Bank4 and Bank5 is coupled to a third bus 112 and a fourth row of the banks 104 including Bank6 and Bank7 is coupled to a fourth bus 114.

Broadly, the banks 104 may be arranged in any manner. The common logic 106 is coupled to the memory banks 106 via the different buses 108-112 (Step 202). A bi-directional tri-state buffer 114 is interposed between adjacent ones of the memory banks 104 along the same bus, segmenting each bus 108-112 into a plurality of sections (Step 204). Each bus section is coupled to one or more different ones of the memory banks 104. In the embodiment illustrated in FIG. 1, a first section 116 of the first bus 108 is coupled to BANK0 while a second section 118 of the first bus 108 is coupled to BANK1. Likewise, a first section 120 of the second bus 110 is coupled to BANK2 while a second section 122 of the second bus 110 is coupled to BANK3 and so on.

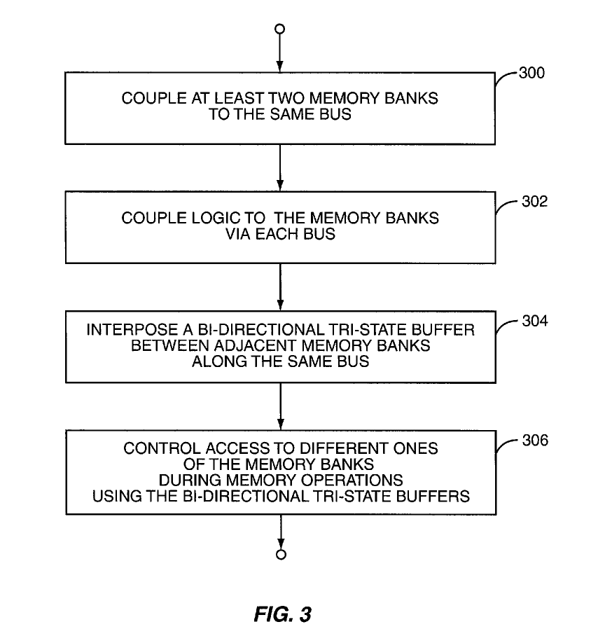

FIG. 3 illustrates an embodiment of a method for operating the memory device 100. Each of the buses 108-112 is coupled to two or more different ones of the memory banks 104 (Step 300). The buses 108-112 are also coupled to the common logic 106 (Step 302). The bi-directional tri-state buffers 114 are interposed between adjacent ones of the memory banks 104 along the same bus, segmenting each bus 108-112 into a plurality of sections (e.g., 116/118, 120/122) as described above (Step 304). Access to the memory banks 104 during memory operations is controlled by the common logic 106 by activating and deactivating different ones of the bi-directional tri-state buffers 114 (Step 306). This way, the data buses 108-112 can be shared by more than one of the memory banks 104 without causing data contention or significantly increasing capacitive loading of the buses 108-112.

In more detail, the common logic 106 includes control logic 124 for determining which bank 104 is to be accessed during a memory operation and what type of operation is being performed. The control logic 124 then activates each bi-directional tri-state buffer 114 interposed between the common logic 106 and the target bank 104 to be accessed. For purely illustrative purposes only, consider a write operation directed to BANK0. The control logic 124 activates each bi-directional tri-state buffer 114 interposed between the common logic 106 and BANK0 along the first bus 108. Broadly, the control logic 124 ensures that a non-contentious data path is provided between the common logic 106 and the memory banks 104 during memory operations.

In one embodiment, the control logic 124 receives information indicating which bank 104 (BANK) is to be accessed during a memory operation and whether the memory operation is a read (R) or write (W). This information may be internally generated by the memory device 100, e.g., by master control logic (not shown) included in the memory device 100. Alternatively, the bank and read/write information may be provided to the control logic 124 from an external memory controller (not shown). Either way, the control logic 124 uses the bank and read/write information to determine which bi-directional tri-state buffers 114 are to be activated during a particular memory operation and which ones are not.

The control logic 124 also deactivates each bi-directional tri-state buffer 114 not disposed along the data path of interest. In one embodiment, the control logic 124 deactivates each bi-directional tri-state buffer 114 located further from the common logic 106 than the target memory bank 104 along the bus that couples the logic 106 to the target bank 104. Each bi-directional tri-state buffer 114 disposed along the other buses may also be deactivated. Consider another purely illustrative example where a read operation is directed to BANK3. The control logic 124 deactivates the bi-directional tri-state buffer 114 interposed between BANK2 and BANK3 along the second data bus 110, preventing data contention between BANK2 and BANK 3 and reducing capacitive loading on the second bus 110 during the read operation. The bi-directional tri-state buffers 114 disposed along the other data buses may also be deactivated. By deactivating the bi-directional tri-state buffers 114 not disposed along the desired data path, the common logic 124 prevents data contention and reduces capacitive loading on the buses 108-112.

The common logic 124 is also coupled to a global data bus (DQ) of the memory device 100. The global data bus is the main data interface between the memory device 100 and devices (not shown) external to the memory device 100. The common logic 124 controls data flow between the global data bus and the memory banks 104 during memory operations. To this end, the common logic 124 includes a multiplexer circuit 126 and a plurality of buffer circuits 128-134. The control logic 124 generates a control signal (CTRL) which is applied to the multiplexer circuit 126. The control signal determines which common logic buffer circuit 128-134 is coupled to the multiplexer circuit 126 during a particular memory operation. The buffer circuit selected depends on which bank 104 is being accessed during the operation. Operation of the common logic buffer circuits 128-134 is controlled similarly to the bi-directional tri-state buffers 114 to minimize data contention and capacitive loading.

In one embodiment, the control logic 124 generates read and write control signals (r/w) that are applied to the common logic buffer circuits 128-134 and to the bi-directional tri-state buffers 114. The state of the read and write control signals is set based on which bank 104 is being accessed and what type of memory operation is being performed. In one embodiment, the read and write control signals are programmed based on the bank (BANK) and read/write (R/W) information provided to the control logic 124 as previously described above.

During a write operation, data present on the global data bus is written to one of the memory banks 104. The common logic 124 enables a data path between the target memory bank 104 and the global data bus by directing the multiplexer circuit 126 to couple the global data bus to the appropriate buffer circuit (e.g., the first buffer circuit 128 when BANK0 is the target memory bank 104). The control logic 124 activates the appropriate buffer circuit by enabling the corresponding write control signal, coupling the buffer circuit to the proper data bus (the first data bus 108 in this example). The control logic 124 also activates each bi-directional tri-state buffer 114 interposed between the common logic 106 and the target bank 104 (BANK0 in this example). I/O (input/output) circuitry 136 associated with the target bank 104 senses the data on the activated bus (the first bus 108 in this example) and writes the data to the addressed memory array location.

During a read operation, data is read from one of the memory banks 104 and driven onto the global data bus. The control logic 124 enables a path between the target memory device 104 and the global data bus by directing the multiplexer circuit 126 to couple the global data bus to the appropriate buffer circuit (e.g., the second buffer circuit 130 when BANK3 is the target memory bank 104). The control logic 124 activates the appropriate buffer circuit by enabling the corresponding read control signal, coupling the buffer circuit to the proper data bus (the second data bus 110 in this example). The control logic 124 also activates each bi-directional tri-state buffer 114 interposed between the common logic 106 and the target bank 104 (BANK3 in this example). In this example, the bi-directional tri-state buffer 114 interposed between BANK2 and BANK3 is deactivated to prevent data contention and reduce capacitive loading on the second data bus 110. The I/O circuitry 136 associated with BANK3 senses the data read out of the bank 104 and drives the sensed data onto the activated bus (the second bus 110 in this example). The data is then driven from the global data bus off-chip.

Broadly, the control logic 124 maintains proper operation of the memory device 100 by programming the read and write buffer control signals (r/w) and controlling the multiplexer circuit 126 based on the bank (BANK) and read/write (R/W) information provided to the control logic 124. This way, the memory banks 104 can share different ones of the data buses 108-112 without causing data contention or degrading memory device performance. Sharing the data buses 108-112 between two or more of the memory banks 104 reduces the overall area of the memory device 100, reduces power consumption and improves performance because fewer bus lines are present to cause capacitive coupling.

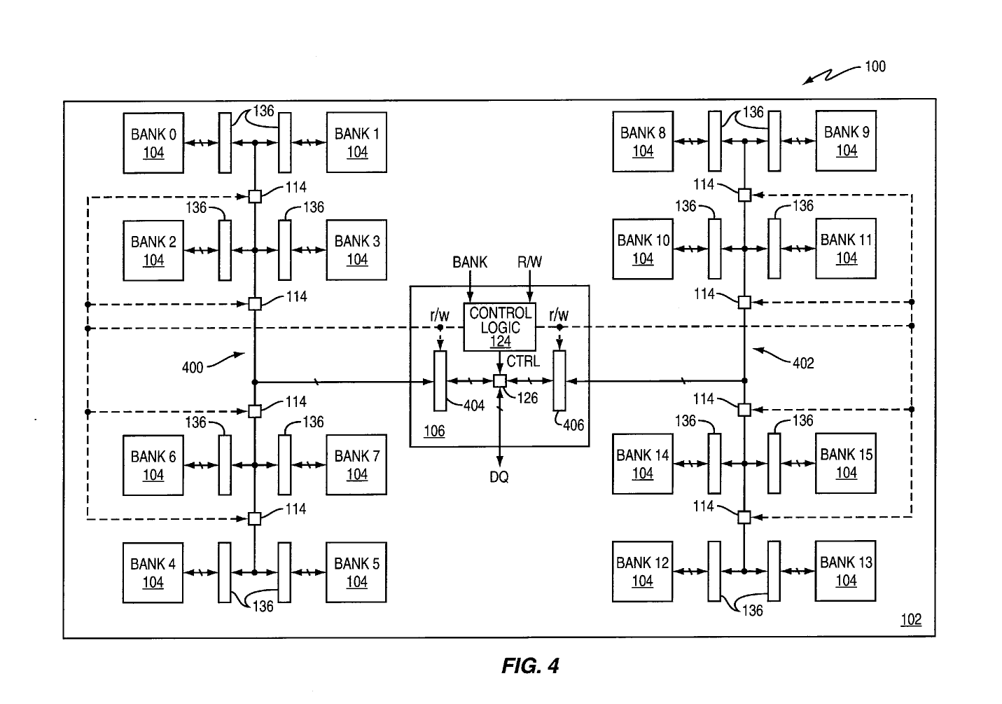

FIG. 4 illustrates another embodiment of the memory device 100. According to this embodiment, the memory banks 104 are arranged in columns. Particularly, a first column of the banks 104 including BANK0 and BANK1 and a second column of including BANK2 and BANK3 are coupled to a first bus 400. A third column of the banks 104 including BANK4 and BANK5 and a fourth column including BANK6 and BANK7 are also coupled to the first bus 400. A fifth column of the banks 104 including BANK8 and BANK9 and a sixth column including BANK10 and BANK11 are coupled to a second bus 402. A seventh column of the banks 104 including BANK12 and BANK13 and an eighth column including banks BANK14 and BANK15 are also coupled to the second bus 402.

According to the embodiment illustrated in FIG. 4, four different columns of memory banks 104 share the same data bus. That is, the first, second, third and fourth bank columns share the first bus 400 while the fifth, sixth, seventh and eight bank columns share the second bus 402. Accordingly, an additional bi-directional tri-state buffer 114 is interposed between the common logic 106 and the memory banks 104 nearest the common logic 106 along the buses 400, 402. This additional bi-directional tri-state buffer 114 prevents bus contention when multiple columns of memory banks 104 share the same data bus. Alternatively, each column of memory banks 104 may have its own bus. Either way, at least two of the memory banks 104 arranged in the same column share the same data bus.

The common logic 106 controls bus access as described above. According to the embodiment shown in FIG. 4, the common logic 106 includes a first buffer circuit 404 coupled to the first bus 400 and a second buffer circuit 406 coupled to the second bus 402. During a memory operation, the control logic 124 determines which bank 104 is to be accessed and what type of operation is to be performed. The control logic 124 activates the appropriate read and write buffer control signals (r/w) and couples the multiplexer circuit 126 to the proper common logic buffer circuit based on this information.

In response, each bi-directional tri-state buffer 114 interposed between the common logic 106 and the target memory bank 104 along the bus that couples the bank 104 to the logic 106 is activated. Each bi-directional tri-state buffer 114 disposed further from the common logic 106 than the target memory bank 104 along the bus that couples the logic 106 to the target bank 104 is deactivated to prevent data contention and reduce capacitive coupling. Each bi-directional tri-state buffer 114 disposed along the other buses may also be deactivated. This way, the target memory bank 104 is coupled to the global data bus (DQ) through the common logic 106 using a shared data bus. Data can be written to or read from the memory device 100 via this path.

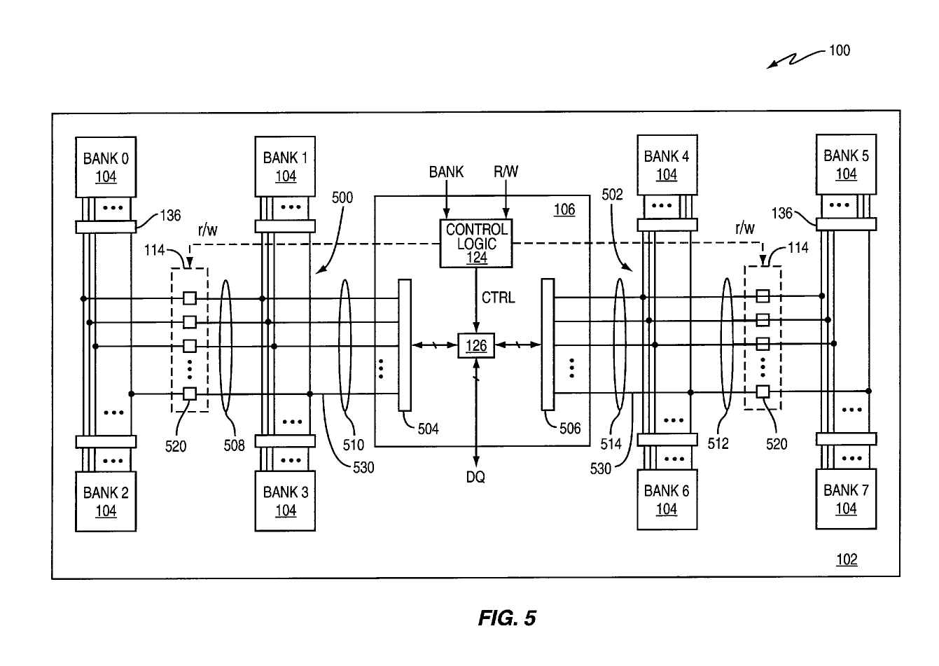

FIG. 5 illustrates yet another embodiment of the memory device 100. According to this embodiment, the memory banks 104 are arranged in rows. Particularly, a first row of the banks 104 including BANK0 and BANK1 is coupled to a first bus 500. A second row of the banks 104 including BANK2 and BANK3 is also coupled to the first bus 500. A third row of the banks 104 including BANK4 and BANK5 is coupled to a second bus 502 and a fourth row including BANK6 and BANK7 is also coupled to the second bus 502. The memory banks 104 may be disposed in any row and/or column arrangement.

Regardless, the bi-directional tri-state buffers 114 are interposed between adjacent ones of the memory banks 104 coupled to the same bus. According to this embodiment, a first one of the bi-directional tri-state buffers 114 is interposed between BANK0/BANK2 and BANK1/BANK3 because BANK0, BANK1, BANK2 and BANK3 share the same bus 500 even though they are in different rows. A second one of the bi-directional tri-state buffers 114 is similarly interposed between BANK5/BANK7 and BANK4/BANK6. The common logic 106 controls bus access as described above. According to the embodiment shown in FIG. 5, the common logic 106 includes a first buffer circuit 504 coupled to the first bus 500 and a second buffer circuit 506 coupled to the second bus 502. During a memory operation, the control logic 124 determines which bank 104 is to be accessed and what type of operation is to be performed. The control logic 124 activates the corresponding read and write buffer control signals (r/w) and couples the multiplexer circuit 126 to the proper buffer circuit based on this information.

In response, each bi-directional tri-state buffer 114 interposed between the common logic 106 and the target memory bank 104 along the bus that couples the bank 104 to the logic 106 is activated. Each bi-directional tri-state buffer 114 disposed further from the common logic 106 than the target memory bank 104 along the bus that couples the logic 106 to the target bank 104 is deactivated to prevent data contention and reduce capacitive coupling. Each bi-directional tri-state buffer 114 disposed along the other buses may also be deactivated. This way, different ones of the memory banks 104 can be coupled to the global data bus (DQ) via the common logic 106 using shared data buses 500, 502 that are segmented into a plurality of sections 508-514 by the bi-directional tri-state buffers 114 disposed along the respective buses 500, 502.

The bi-directional tri-state buffers 114 are shown in more detail in FIG. 5. The bi-directional tri-state buffers 114 include a buffer element 520 inserted into each bit line 530 of the data buses 500, 502 between adjacent ones of the memory banks 104. Each buffer element 520 couples one section of a bit line 530 to the adjacent bit line section. Together, the buffer elements 520 segment each data bus 500, 502 into multiple sections 508-512, each bus section 508-512 being coupled to one or more different ones of the memory banks 104.

The embodiment illustrated in FIG. 5 shows the first data bus 500 being segmented into two sections 508, 510 by the buffer elements 520 included in the bi-directional tri-state buffer 114 inserted into the first bus 500 between BANK0/BANK2 and BANK1/BANK3. Each data bit line 530 of the first section 508 is coupled to both BANK0 and BANK2. Each data bit line 530 of the second section 510 is similarly coupled to both BANK1 and BANK3. Data is read from or written to any one of the four banks 104 coupled to the first bus 500 by selecting the target bank 104 and either activating or deactivating the buffer elements 520 disposed between BANK0/BANK2 and BANK1/BANK3 along the first bus 500 as described above.

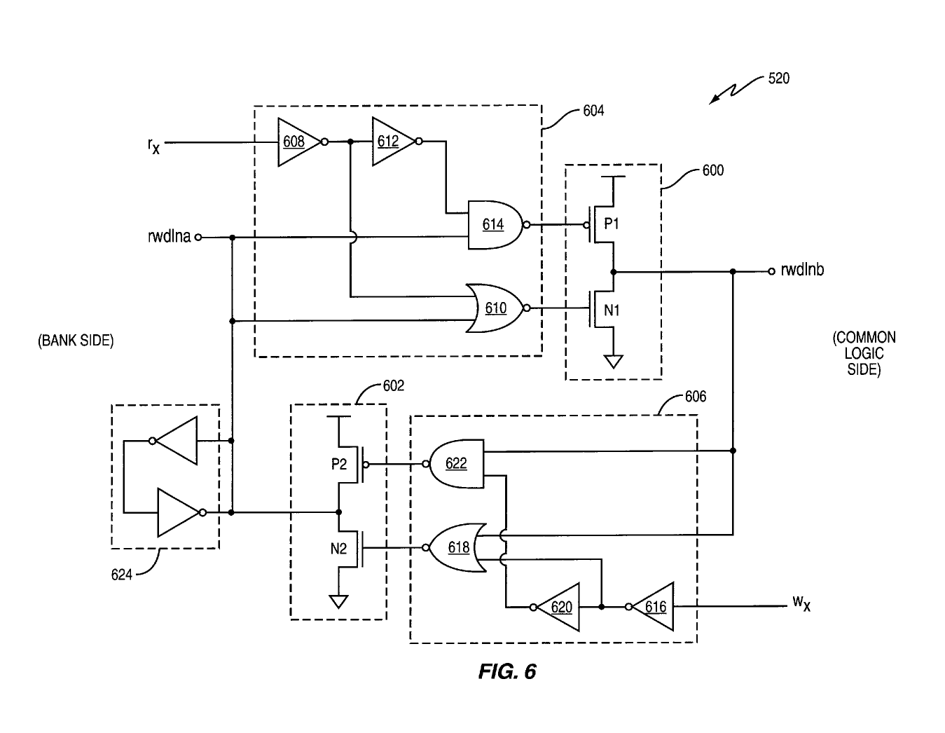

FIG. 6 illustrates an embodiment of the buffer elements 520 of the rth bi-directional tri-state buffer 114. According to this embodiment, the buffer element 520 includes a first data line port (rwdlna) and a second data line port (rwdlnb). The buffer element 520 is inserted into the nth data line of a bus, effectively segmenting the nth data line into two sections. The first port is coupled to the bank-side section of the nth data line while the second port is coupled to the common logic-side section of the same data line. The buffer element 520 further includes read driver circuitry 600 for driving data from the bank-side section of the nth data line to the common logic-side section of the same data line. The buffer element 520 also includes write driver circuitry 602 for driving data from the common logic-side section of the nth data line to the bank-side section of the same data line. This way, data can be transferred in either direction along the nth data line through the buffer element 520.

The buffer element 520 has additional circuitry 604, 606 for controlling when the read and write driver circuitry 600, 602 is enabled, respectively. During a read operation, a first circuit 604 enables the read driver circuitry 600 when the target memory bank 104 is coupled to the same bus as the buffer element 520 and the buffer element 520 is interposed between the target bank 104 and the common logic 106, i.e., the buffer element 520 is disposed in the desired data path. Under these conditions, the common logic 106 activates the read control signal (rₓ) applied to the buffer element 520 of the rth bi-directional tri-state buffer 114. In response, a first inverter 608 and NOR gate 610 of the first circuit 604 activates an n-FET device N1 of the read driver circuitry 600. A second inverter 612 of the first circuit 604 causes the output of a NAND gate 614 of the first circuit 604 to be a function of the state of the first data line port (rwdlna).

One bit of data to be read from the target memory bank 104 is present on the first data line port. When this data bit is a logic one, the NAND gate 614 outputs a logic zero to a p-FET device P1 of the read driver circuitry 600. The p-FET device P1 in turn drives the second data line port (rwdlnb) to a logic one state. The n-FET device N1 of the read driver circuitry 600 similarly drives the second data line port to a logic zero state when the first data line port is at a logic zero state. The common logic 106 deactivates the write control signal (wₓ) applied to the buffer element 520 during read operations to disable the write driver circuitry 602, preventing data contention between the first and second data line ports.

During write operations, a second circuit 606 enables the write driver circuitry 602 when the buffer element 520 is interposed in the data path of interest, i.e., between the target memory bank 104 and the common logic 106. Under these conditions, the common logic 106 deactivates the read control signal (rₓ) and activates the write control signal (wₓ). In response, a first inverter 616 and NOR gate 618 of the second circuit 606 activates an n-FET device N2 of the write driver circuitry 602. A second inverter 620 of the second circuit 606 causes the output of a NAND gate 622 of the second circuit 606 to be a function of the state of the second data line port (rwdlnb).

One bit of data to be written to the target memory bank 104 is present on the second data line port. When this data bit is a logic one, the NAND gate 622 of the second circuit 606 outputs a logic zero to a p-FET device P2 of the write driver circuitry 602. The p-FET device P2 correspondingly drives the first data line port (rwdlna) to a logic one state. The n-FET device N2 of the write driver circuitry 602 similarly drives the first data line port to a logic zero state when the second data line port is at a logic zero state. A keeper circuit 624 stores the current bit of data output by the write driver circuitry 602 in the buffer element 520. The read control signal (rₓ) is disabled during write operations to disable the read driver circuitry 600, preventing data contention between the first and second data line ports.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. A memory device, comprising:
a plurality of memory banks, wherein at least two of the memory banks share the same bus;
logic coupled to the memory banks via the different buses and operable to control access to the memory banks; and
a bi-directional tri-state buffer interposed between adjacent memory banks along the same bus so that each bus is segmented into a plurality of sections, each bus section being coupled to one or more different ones of the memory banks.

2. The memory device of claim 1, wherein the memory banks are arranged in a plurality of rows or columns and each bi-directional tri-state buffer is interposed between adjacent ones of the memory banks arranged in the same row or column.

3. The memory device of claim 1, wherein the logic is operable to:
determine which bank is to be accessed during a memory operation; and
activate each bi-directional tri-state buffer interposed between the logic and the bank to be accessed along the bus that couples the bank to the logic.

4. The memory device of claim 3, wherein the memory operation is a read operation and the logic is operable to activate read driver circuitry included in each bi-directional tri-state buffer interposed between the logic and the bank to be accessed during the read operation along the bus that couples the bank to the logic.

5. The memory device of claim 3, wherein the memory operation is a write operation and the logic is operable to activate write driver circuitry included in each bi-directional tri-state buffer interposed between the logic and the bank to be accessed during the write operation along the bus that couples the bank to the logic.

6. The memory device of claim 3, wherein the logic is operable to deactivate each bi-directional tri-state buffer disposed further from the logic than the bank to be accessed along the bus that couples the logic to the bank to be accessed.

7. A method of fabricating a memory device, comprising:
disposing a plurality of memory banks on a substrate, wherein at least two of the memory banks share the same bus;
coupling logic to the memory banks via the different buses, wherein the logic is operable to control access to the memory banks; and
interposing a bi-directional tri-state buffer between adjacent memory banks along the same bus so that each bus is segmented into a plurality of sections, each bus section being coupled to one or more different ones of the memory banks.

8. The method of claim 7, wherein the memory banks are arranged in a plurality of rows or columns on the substrate and wherein interposing a bi-directional tri-state buffer between adjacent memory banks along the same bus comprises interposing each bi-directional tri-state buffer between different ones of the memory banks arranged in the same row or column.

9. A method of operating a memory device, comprising:
coupling at least two of a plurality of memory banks to the same bus;
coupling logic to the memory banks via each bus;
interposing a bi-directional tri-state buffer between adjacent memory banks along the same bus so that each bus is segmented into a plurality of sections, each bus section being coupled to one or more different ones of the memory banks; and
controlling access to different ones of the memory banks during memory operations using the bi-directional tri-state buffers.

10. The method of claim 9, wherein controlling access to different ones of the memory banks during memory operations using the bi-directional tri-state buffers comprises:
determining which bank is to be accessed during a memory operation; and
activating each bi-directional tri-state buffer interposed between the logic and the bank to be accessed along the bus that couples the bank to the logic.

11. The method of claim 10, wherein activating each bi-directional tri-state buffer interposed between the logic and the bank to be accessed along the bus that couples the bank to the logic comprises activating read driver circuitry included in each bi-directional tri-state buffer interposed between the logic and the bank to be accessed during a read operation along the bus that couples the bank to the logic.

12. The method of claim 10, wherein activating each bi-directional tri-state buffer interposed between the logic and the bank to be accessed along the bus that couples the bank to the logic comprises activating write driver circuitry included in each bi-directional tri-state buffer interposed between the logic and the bank to be accessed during a write operation along the bus that couples the bank to the logic.

13. The method of claim 10, further comprising deactivating each bi-directional tri-state buffer disposed further from the logic than the bank to be accessed along the bus that couples the logic to the bank to be accessed.

14. A memory device, comprising:
a first group of memory banks operable to share a first bus;
a second group of memory banks operable to share a second bus;
logic coupled to the groups of memory banks via the respective buses, the logic operable to control access to the memory banks; and
wherein each bus is segmented into a plurality of sections by one or more bi-directional tri-state buffers, each bi-directional tri-state buffer interposed between adjacent ones of the memory banks that share the same bus.

15. The memory device of claim 14, wherein the logic is operable to:
determine which bank is to be accessed during a memory operation; and
activate each bi-directional tri-state buffer interposed between the logic and the bank to be accessed along the bus that couples the bank to the logic.

16. The memory device of claim 15, wherein the memory operation is a read operation and the logic is operable to activate read driver circuitry included in each bi-directional tri-state buffer interposed between the logic and the bank to be accessed during the read operation along the bus that couples the bank to the logic.

17. The memory device of claim 15, wherein the memory operation is a write operation and the logic is operable to activate write driver circuitry included in each bi-directional tri-state buffer interposed between the logic and the bank to be accessed during the write operation along the bus that couples the bank to the logic.

18. The memory device of claim 15, wherein the logic is operable to deactivate each bi-directional tri-state buffer disposed further from the logic than the bank to be accessed along the bus that couples the logic to the bank to be accessed.

19. A memory device, comprising:
a first group of memory banks operable to share a bus;
a second group of memory banks operable to share the same bus with the first group of memory banks;
logic coupled to the groups of memory banks via the bus, the logic operable to control access to the memory banks; and
wherein the bus is segmented into a plurality of sections by one or more bi-directional tri-state buffers, each bi-directional tri-state buffer interposed between adjacent ones of the memory banks along the bus.

20. The memory device of claim 19, wherein the logic is operable to:
determine which bank is to be accessed during a memory operation; and
activate each bi-directional tri-state buffer interposed between the logic and the bank to be accessed.

21. The memory device of claim 20, wherein the memory operation is a read operation and the logic is operable to activate read driver circuitry included in each bi-directional tri-state buffer interposed between the logic and the bank to be accessed during the read operation.

22. The memory device of claim 20, wherein the memory operation is a write operation and the logic is operable to activate write driver circuitry included in each bi-directional tri-state buffer interposed between the logic and the bank to be accessed during the write operation.

23. The memory device of claim 20, wherein the logic is operable to deactivate each bi-directional tri-state buffer disposed further from the logic than the bank to be accessed along the bus.

24. A system comprising a memory device having a plurality of memory banks with at least two of the memory banks operable to share the same bus, logic coupled to the memory banks via the different buses and operable to control access to the memory banks and a bi-directional tri-state buffer interposed between adjacent memory banks along the same bus so that each bus is segmented into a plurality of sections, each bus section being coupled to one or more different ones of the memory banks.
